(19) United States
(12) Patent Application Publication
(10) Pub. No.: US 2026/0057599 A1
(43) Pub. Date: Feb. 26, 2026

(54) DENSER RAY CASTING FOR VIEW TRANSFORM NETWORKS FOR DRIVER ASSISTANCE

(71) Applicant: QUALCOMM Incorporated, San Diego, CA (US)

(72) Inventors: Andreas Sjadin Hallstrand, Linköping (SE); Simon Keisala, Linköping (SE); Mattis Lorentzon, Vikingstad (SE)

(21) Appl. No.: 18/812,154

(22) Filed: Aug. 22, 2024

(51) Int. Cl. G06T 15/06; B60W 50/14; G06T 5/20; G06T 7/50; G06T 7/70; G06V 10/44

(52) U.S. Cl. CPC G06T 15/06; B60W 50/14; G06T 5/20; G06T 7/50; G06T 7/70; G06V 10/44; G06V 2201/07

(57) ABSTRACT

An apparatus includes a memory for storing image data; and processing circuitry in communication with the memory. The processing circuitry is configured to obtain a plurality of camera images and generate camera features from the plurality of camera images. According to such an example, processing circuitry may be configured to project the camera features from the plurality of camera images into a birds-eye-view (BEV) image space to generate BEV features. In certain examples, processing circuitry is configured to determine a plurality of zero-value locations of the BEV features within the BEV image space and diffuse non-zero BEV features in the BEV image space into the plurality of zero-value locations within the BEV image space to generate increased density BEV features. In at least one example, processing circuitry is configured to output a BEV image having the increased density BEV features.

### TECHNICAL FIELD

This disclosure relates to sensor systems, including image projections for use in advanced driver-assistance systems (ADAS).

### BACKGROUND

An autonomous driving vehicle is a vehicle that is configured to sense the environment around the vehicle, such as the existence and location of other objects, and to operate without human control. An autonomous driving vehicle may include cameras that produce image data that may be analyzed to determine the existence and location of other objects around the autonomous driving vehicle. A vehicle having advanced driver-assistance systems (ADAS) is a vehicle that includes systems which may assist a driver in operating the vehicle, such as parking or driving the vehicle.

### SUMMARY

The present disclosure generally relates to techniques and devices for generating camera features based on image data, such as image data obtained from camera images. In particular, this disclosure describes techniques for densifying feature information within a bird's eye view (BEV) image space to improve generation of a BEV image as output. Image transformations from image data may be performed utilizing a variety of methods, including application of a lift stage of a lift, splat, shoot (LSS) process used to generate a BEV projection from a plurality of camera images. The BEV features include a variety of information which may be consumed by a machine learning model to generate useful output or perform a useful output task. For instance, the BEV features may include depth probabilities estimated for various areas of the BEV image space consumed by another downstream task to perform a task. In other examples, a machine learning model utilizes the BEV feature(s) and responsively provides useful output or useful output tasks, such as object detection, object segmentation, displaying detected objects in a BEV format, providing a list of detected objects with their locations and predicted paths to another downstream function, identifying lane markers, displaying an area around a vehicle in a Bird's-Eye-View to back-up camera display, and so forth. There are many useful tasks and outputs that a BEV grid network may support utilizing the BEV features.

Techniques of this disclosure may include projecting the BEV features, including the depth probabilities, outward into discrete feature pixels along rays in the BEV image space representing a real-world view of a 3-dimensional space. Projecting the BEV features may produce both densely populated and sparsely populated regions within the BEV image space, such as between adjacent rays, with sparsity increasing with distance from an image source. Techniques include increasing information density within the BEV image space through the application of convolution operations to zero-value locations (e.g., BEV feature locations between rays lacking depth information). The convolution operations may diffuse information from neighboring BEV feature locations into the zero-value locations within the regions of information sparsity. In such a way, BEV features, including depth information from neighboring locations, are diffusely spread into the zero-value locations, thus supplanting the zero-values (e.g., no information) with down-sampled feature and/or depth information derived from the neighboring locations.

Down-sampled feature and/or depth information may be scattered into the sparse (e.g., zero-value) locations to increase overall information density within the BEV image space to improve subsequent automotive perception tasks in a computationally efficient manner. For instance, the increased information density may enable one or more machine learning models to attain equivalent results in a more efficient manner by eliminating convolution layers after a view transform operation, thus eliminating the need for the one or more machine learning models to transport feature information from the non-zero-value locations into the initially empty zero-value locations. The techniques of this disclosure, including offloading such feature transport operations, may therefore increase operational efficiency of the machine learning models performing automotive perception tasks, reduce complexity of the machine learning models, increase predictive output accuracy of the machine learning models, reduce processor burdens, reduce data transfer delays, reduce overall power usage, or some combination thereof.

In one example, an apparatus for processing image data, the apparatus includes a memory for storing the image data; and processing circuitry in communication with the memory. According to such an example, the processing circuitry is configured to obtain a plurality of camera images and generate camera features from the plurality of camera images. According to such an example, processing circuitry may be configured to project the camera features from the plurality of camera images into a birds-eye-view (BEV) image space to generate BEV features. In certain examples, processing circuitry is configured to determine a plurality of zero-value locations of the BEV features within the BEV image space and diffuse non-zero BEV features in the BEV image space into the plurality of zero-value locations within the BEV image space to generate increased density BEV features. In at least one example, processing circuitry is configured to output a BEV image having the increased density BEV features.

In another example, a method includes obtaining a plurality of camera images and generating camera features from the plurality of camera images. The example method may further include projecting the camera features from the plurality of camera images into a birds-eye-view (BEV) image space to generate BEV features. According to at least one example, the example method includes determining a plurality of zero-value locations of the BEV features within the BEV image space and diffusing non-zero BEV features in the BEV image space into the plurality of zero-value locations within the BEV image space to generate increased density BEV features. The example method may also include outputting a BEV image having the increased density BEV features.

In another example, a non-transitory computer-readable medium stores instructions that, when executed, cause processing circuitry to obtain a plurality of camera images and generate camera features from the plurality of camera images. According to such an example, the instructions, when executed, project the camera features from the plurality of camera images into a birds-eye-view (BEV) image space to generate BEV features. In certain examples, the instructions, when executed, determine a plurality of zero-value locations of the BEV features within the BEV image space and diffuse non-zero BEV features in the BEV image space into the plurality of zero-value locations within the BEV image space to generate increased density BEV features. In at least one example, the instructions, when executed, output a BEV image having the increased density BEV features.

In another example, an apparatus includes means for obtaining a plurality of camera images and generating camera features from the plurality of camera images. The apparatus may further include means for projecting the camera features from the plurality of camera images into a birds-eye-view (BEV) image space to generate BEV features. According to at least one example, apparatus includes means for determining a plurality of zero-value locations of the BEV features within the BEV image space and means for diffusing non-zero BEV features in the BEV image space into the plurality of zero-value locations within the BEV image space to generate increased density BEV features. The apparatus may further include means for outputting a BEV image having the increased density BEV features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one or more techniques of this disclosure.

FIG. 2 is a block diagram illustrating an architecture for processing image data to generate predictive output from a bird's eye view (BEV) image space, in accordance with one or more techniques of this disclosure.

FIG. 3 is a flow diagram illustrating view transformation and ray densification, in accordance with one or more techniques of this disclosure.

FIG. 4 is a diagram of an example convolution filter applied to zero value locations to densify camera features within a BEV image space, in accordance with one or more techniques of this disclosure.

FIG. 5 depicts an example view transform output map before information densification, in accordance with one or more techniques of this disclosure.

FIG. 6 is a flow diagram illustrating an example method for densifying rays sparsely cast into a bird's eye view (BEV) image space to improve subsequent BEV image generation, in accordance with one or more techniques of this disclosure.

### DETAILED DESCRIPTION

Camera systems may be used in various different robotic, vehicular, and virtual reality (VR) applications. One such vehicular application is an advanced driver assistance system (ADAS). ADAS may be a system that uses camera technology to improve driving safety, comfort, and overall vehicle performance.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be used in vehicular, robotic, and VR applications as sources of information that may be used to determine the location, pose, and potential actions of physical objects in the outside world.

The present disclosure generally relates to techniques and devices for generating features based on image data, such as image data obtained from camera images. In particular, this disclosure describes techniques for densifying feature information within a bird's eye view (BEV) image space to improve generation of a BEV image as output. Image transformations from image data may be performed utilizing a variety of methods, including application of a lift stage of a lift, splat, shoot (LSS) process used to generate a BEV projection from a plurality of camera images. The BEV features include a variety of information which may be consumed by a machine learning model to generate useful output or perform a useful output task. For instance, the BEV features may include depth probabilities estimated for various areas of the BEV image space consumed by another downstream task to perform a task. In other examples, a machine learning model utilizes the BEV feature(s) and responsively provides useful output or useful output tasks, such as object detection, object segmentation, displaying detected objects in a BEV format, providing a list of detected objects with their locations and predicted paths to another downstream function, identifying lane markers, displaying an area around a vehicle in a Bird's-Eye-View to back-up camera display, and so forth. There are many useful tasks and outputs that a BEV grid network may support utilizing the BEV features.

Techniques of this disclosure may include projecting the BEV features, including the depth probabilities, outward into discrete feature pixels along rays in the BEV image space representing a real-world view of a 3-dimensional space. Projecting the BEV features may produce both densely populated and sparsely populated regions within the BEV image space, such as between adjacent rays, with sparsity increasing with distance from an image source. Techniques include increasing information density within the BEV image space through the application of convolution operations to zero-value locations (e.g., BEV feature locations between rays lacking depth information). The convolution operations may diffuse information from neighboring BEV feature locations into the zero-value locations within the regions of information sparsity. In such a way, BEV features, including depth information from neighboring locations, are diffusely spread into the zero-value locations, thus supplanting the zero-values (e.g., no information) with down-sampled feature and/or depth information derived from the neighboring locations.

Down-sampled feature and/or depth information may be scattered into the sparse (e.g., zero-value) locations to increase overall information density within the BEV image space to improve subsequent automotive perception tasks in a computationally efficient manner. For instance, the increased information density may enable one or more machine learning models to attain equivalent results in a more efficient manner by eliminating convolution layers after a view transform operation, thus eliminating the need for the one or more machine learning models to transport feature information from the non-zero-value locations into the initially empty zero-value locations. The techniques of this disclosure, including offloading such feature transport operations, may therefore increase operational efficiency of the machine learning models performing automotive perception tasks, reduce complexity of the machine learning models, increase predictive output accuracy of the machine learning models, reduce processor burdens, reduce data transfer delays, reduce overall power usage, or some combination thereof.

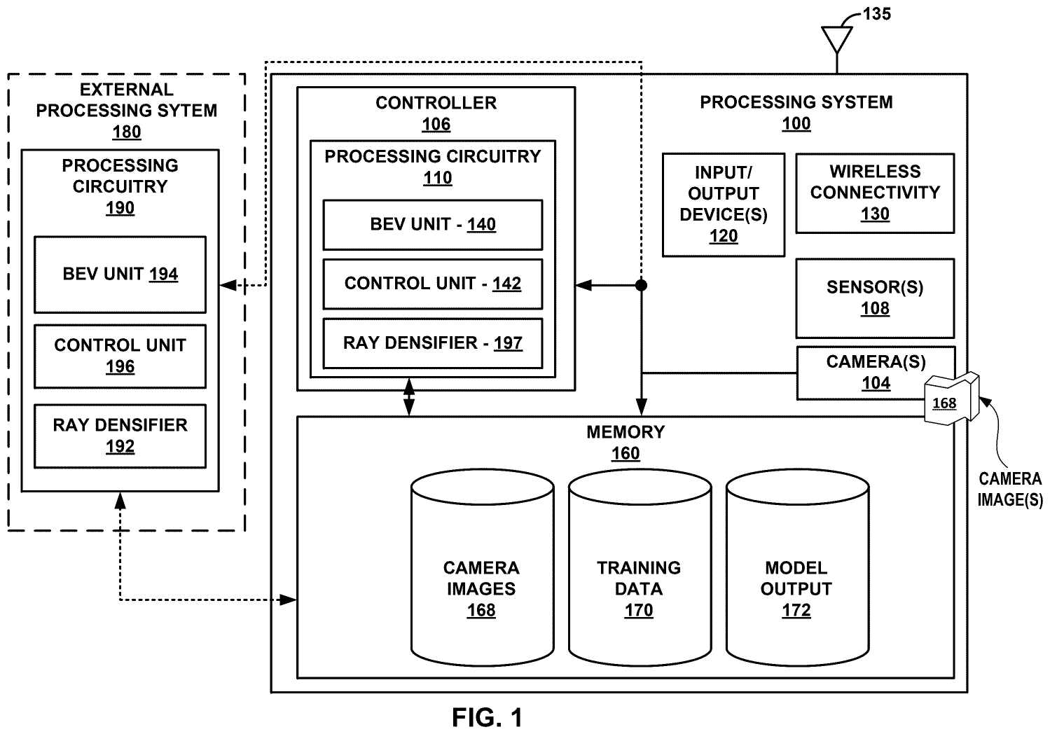

FIG. 1 is a block diagram illustrating an example processing system 100, in accordance with one to more techniques of this disclosure. Processing system 100 may be used in an apparatus, such as a vehicle, including an autonomous driving vehicle or an assisted driving vehicle (e.g., a vehicle having an advanced driver-assistance system (ADAS) or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

Processing system 100 may include camera(s) 104, controller 106, one or more sensor(s) 108, input/output device(s) 120, wireless connectivity component 130, and memory 160. Camera(s) 104 may be any type of camera configured to capture video or image data in the environment around processing system 100 (e.g., around a vehicle). In some examples, processing system 100 may include multiple cameras 104. For example, camera(s) 104 may include a front-facing camera (e.g., a front bumper camera, a front windshield camera, and/or a dashcam), a back-facing camera (e.g., a backup camera), side-facing cameras (e.g., cameras mounted in sideview mirrors). Camera(s) 104 may be a color camera or a grayscale camera. In some examples, camera(s) 104 may be a camera system including more than one camera sensor. Camera(s) 104 may, in some examples, be configured to collect camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of a vehicle through the environment surrounding the vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller may include a row decoder, column decoder, or both. In some cases, memory cells within memory 160 store information in the form of a logical state.

Processing system 100 may be configured to perform techniques for obtaining image data, including camera images 168 from camera(s) 104 of processing system 100 and extracting camera features from the image data and position data. Processing system 100 may also be configured to process the camera features, fuse the features, project the camera features into BEV image space, determine areas of information sparsity within the camera features, filter certain camera features, diffuse and “densify” the camera features in the BEV image space, or any combination thereof. For example, processing circuitry 110 may include BEV unit 140. BEV unit 140 may be implemented in software, firmware, and/or any combination of hardware described herein. BEV unit 140 may be configured to receive or obtain camera images 168 captured by camera(s) 104. BEV unit 140 may be configured to receive camera images 168 directly from camera(s) 104, or from memory 160. In some examples, the plurality of camera images 168 may be referred to herein as “image data.” Moreover, camera images 168 may include static images, video imagery, a video stream, LiDAR data, radar data, or some combination thereof.

In general, BEV unit 140 may apply any of a variety of image transformation operations to generate Bird's Eye View (BEV) features from cameras. For instance, one technique includes application of Lift, Splat, Shoot (LSS) to generate the BEV features from cameras which may be projected into (e.g., fused) BEV space using known camera geometry. As discussed below, BEV unit 140 may generate BEV images based on image data captured by multiple cameras (e.g., a two-dimensional (2D) images) in a manner that produces less data and thus reduces processor burdens, external data transfer delays, and power usage.

Lift, Splat, Shoot (LSS) may generate estimated depth distributions based on camera features generated from camera images 168. In a lift stage, features in each image may be “lifted” from a local 2-dimensional coordinate system to a 3-dimensional (3D) frame that is shared across all cameras. The lift process is repeated for each camera of a multi-camera system (e.g., camera(s) 104). The splat process of LSS is then performed for all of the lifted images into a single representation (e.g., the BEV representation).

To accurately determine a 3D frame, depth information is used but the “depth” associated with each pixel is ambiguous. A Lift, Splat, Shoot operation may utilize representations at many possible depths for each camera feature location (e.g., each pixel of a projected ray) using a depth vector. The depth vector, or depth distribution, may be predicted by a machine learning model, such as a deep neural net (DNN). The depth distribution may be learnt using supervised depth or as a latent representation. In supervised learning, the ground truth depth from a measurement or a sensor, such as a LiDAR sensor, is used to train the machine learning model based on calculated losses between the ground truth depth and predictive output during each training epoch by the machine learning model.

The depth vector is a plurality of depth estimate values along a ray from the camera center to a pixel in the image, where each value represents the probability that the pixel in the image is at a particular depth. Because the values of the depth vector are probabilities, the total of the values in the depth vector will add up to 1. The depth vector may be any length (e.g., number of possible depth values). The longer the depth vector, the more granular the depth values that may be detected, but at the cost of a larger data size. In one example, the depth vector length is 128, but other depth vector lengths may be used.

A context vector of camera features (also called a feature vector) may be constructed using a machine learning model for each pixel. The context vector may be related to attention and may indicate different possible identities or classifications for a pixel. The context vector includes a plurality of values that indicate the probability that a particular pixel represents a particular feature. That is, each value in the context vector may represent a different possible feature. For autonomous driving, features may be used to detect certain types of objects, including cars, trucks, bikes, pedestrians, signs, bridges, road markings, curbs, or other physical objects in the world that may be used to make autonomous driving decisions. The number of values in the context vector is indicative of the number of features that are to be detected in the image. One example context vector length is 80, but more or fewer features may be detected depending on the use case.

To perform the lift process, BEV unit 140 may be configured to combine the depth vector and the context vector using an outer product operation. For a depth vector length (D_{size}) of 128 and a context vector length (C_{size}) of 80, this combination results in a large expansion of layer output volume (frustum_volume) as the layer output volume is proportional to the number of cameras (num_cameras), the image size (represented by image_width and image _height), the length of the depth vector (D_{size}), and the length of the context vector (C_{size}), as shown below:

frustum_volume=num_cameras * (image_width/8) * (image_height/8) * D_{size} * Cs_{ize.}

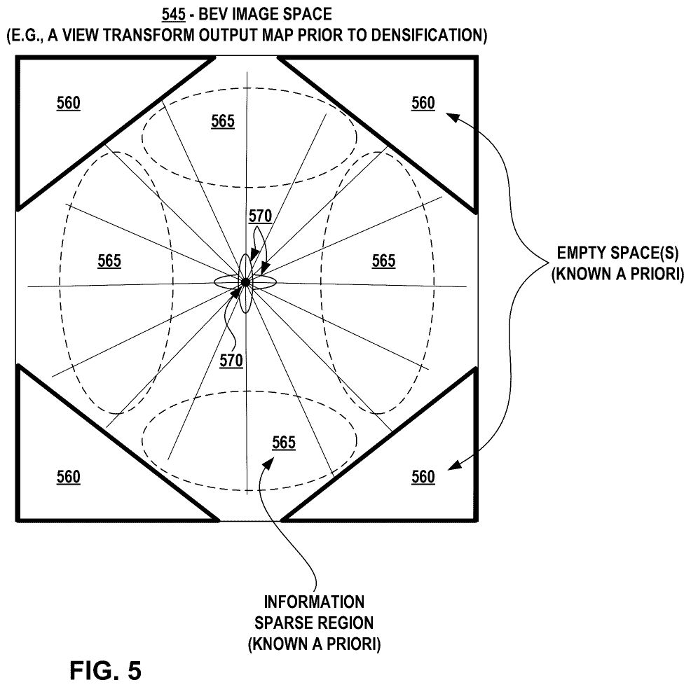

In accordance with the techniques of this disclosure, BEV unit 140 may project camera features into a BEV image space resulting in empty regions lacking any feature or depth information, regions of information density nearest a source of camera images 168 (e.g., corresponding with location(s) of camera(s) 104), and regions of information sparsity which become increasingly sparse with greater distance from the source of camera images 168 for camera images projected radially outward from the source. Refer to the discussion of FIG. 5 below depicting each of the empty regions, regions of information density, and regions of information sparsity.

In the context of computer vision, and specifically when performing camera perception tasks, an image transform operation projects camera features out along rays into a representation of the real-world utilizing distinct depth values represented by the term “D”, with each of the distinct depth values (D) being assigned a corresponding estimated depth probability. As noted above, the sum of the locations yields a distribution which adds up to a value of “1”.

Consider an example processing system for a vehicle having four distinct cameras 104 and therefore, four different sources of camera images 168. In such an example, BEV unit 140 projects image information from each of cameras 104 along rays extending out into BEV image space (e.g., such as a BEV grid or a BEV image map) that is a representative model of the real-world environment around a vehicle. In such an example, each pixel or feature location in the resulting plot formed by the BEV image space corresponds to a BEV grid cell referred to as a location within the BEV image space. Because the rays are projected radially outward from one or more source points located at a center of the BEV image space, the locations along the projected rays will have non-zero values whereas the locations between the projected rays will have no information, resulting in a zero-value location at such locations between the projected rays. Moreover, because the rays are projected out along a discreet number of pixel locations (e.g., such as 48 pixels per ray), any location beyond the length of the rays will similarly result in a zero-value location. The zero-value locations are the result of an initial view transform for the camera images 168 not projecting any information to the corresponding BEV grid cell location.

BEV unit 140 may be configured to perform object detections and other perception tasks for each cell location within the BEV grid, including both non-zero value locations having camera feature information as well as zero-value locations between the projected rays and beyond the projected rays lacking any such camera feature information.

Some example techniques utilize additional convolution layers within a machine learning model configured to perform perception tasks after performing the view transformation operation to transport camera feature information from non-zero value cells having information into the initially empty zero-value cells. While such an approach is functionally satisfactory in providing a BEV image as output from the trained machine learning model, the technique is computationally burdensome as the convolutions of the machine learning model performs double work, both the transportation of camera feature information from populated locations into zero-value locations as well as the building of abstract features, ultimately wasting model capacity on the feature transportation tasks. Further still, utilization of long-bypass layers in encoder-decoder architectures to long bypass an initial view transformed layer with a deeper layer added to the model results in a sparse initial layer with the deeper layer being much denser due to the intermediate convolution layers, leading to overall worse long-bypass utilization since the layers do not spatially overlap well.

Alternatively, higher resolution camera images 168 may be optionally obtained, assuming higher-resolution image capturing hardware is present within processing system 100, from which a greater quantity of camera features may be generated and projected into the BEV image space resulting in overall greater information density. However, this approach also is computationally inefficient due to the increased bandwidth, storage, and CPU/processing circuitry operations consumed by the processing of the higher-resolution image data.

Especially within the context of computer vision applied to the control of vehicles, such as within an advanced driver assistance system (ADAS) type processing system 100, reduction of processing latency delays and computationally efficient operation may enable more accurate and more responsive vehicle control and overall improved BEV image output.

In accordance with aspects of the disclosure, processing circuitry 110 may further include ray densifier 197 which enables off-loading of computational burdens from a BEV grid network operating within BEV unit 140. In other examples, ray densifier 197 may operate within BEV unit 140. Similarly, ray densifier 192 may operate within processing circuitry 190 of external processing system 180 and may optionally be configured within BEV unit 194 of external processing system 180 to offload computational burdens from a BEV grid network operating within BEV unit 194. In such examples, ray densifier 192, 197 offloads information transport operations from the BEV grid network of BEV unit 140, 194 through the application of post-processing operations after the view transform to diffuse information along populated non-zero value locations into neighboring zero-value locations (e.g., such as the zero-value locations located between projected rays of the BEV image space). By densifying information within the BEV grid space utilizing ray densifier 197, a machine learning model may apply its convolution capacity to the building of abstract features resulting in improved predictive output, such as more accurate object detection, more accurate depth estimation, and an overall improved model representation of the real-world environment within which a vehicle is operating.

In some examples, processing circuitry 110 may be configured to train one or more machine learning models such as encoders, decoders, positional encoding models, or any combination thereof applied by BEV unit 140 using training data 170. For example, training data 170 may include one or more training camera images along with ground truth data from a range sensor such as a LiDAR sensor. Training data 170 may additionally or alternatively include features known to accurately represent one or more point cloud frames and/or features known to accurately represent one or more camera images. This may allow processing circuitry 110 to train an encoder to generate features that accurately represent camera images.

Processing circuitry 110 of controller 106 may apply control unit 142 to control, based on the generated BEV image, an object (e.g., a vehicle, a robotic arm, or another object that is controllable based on the output from BEV unit 140) corresponding to processing system 100. Control unit 142 may control the object based on information included in the output generated by BEV unit 140 relating to one or more objects within a 3D space including processing system 100. For example, the output generated by BEV unit 140 may include BEV images, an identity of one or more objects, a position of one or more objects relative to the processing system 100, characteristics of movement (e.g., speed, acceleration) of one or more objects, or any combination thereof. Based on this information, control unit 142 may control the object corresponding to processing system 100. The output from BEV unit 140 may be stored in memory 160 as model output 172.

The techniques of this disclosure may also be performed by external processing system 180. That is, encoding input data, transforming features into BEV images, (including depth and context vector generation, depth distribution and depth probability estimation, camera feature information densification, and other features) may be performed by a processing system that does not include the various sensors shown for processing system 100. Such a process may be referred to as “offline” data processing, where the output is determined from camera images received from processing system 100. External processing system 180 may send an output to processing system 100 (e.g., an ADAS or vehicle).

While ray densifier 197 is depicted as part of processing circuitry 110 for controller 106, ray densifier 192 may optionally be included within processing circuitry 190 for external processing system 180. For instance, ray densifier 192 may be included within external processing system 180 for computer vision operations which are less time-sensitive, more computationally burdensome, or generally more resilient to operational latencies. In other examples, ray densifier 197 and 192 units are included in both processing circuitry 110 of controller 106 and also within external processing system 180 respectively, thus enabling certain computer vision tasks to be performed offline, off-loaded into the cloud, and/or performed by other remote external processing system 180 with low-latency operations being performed locally by processing system 100.

External processing system 180 may include processing circuitry 190, which may be any of the types of processors described above for processing circuitry 110. Processing circuitry 190 may include a BEV unit 194 configured to perform the same processes as BEV unit 140. Processing circuitry 190 may acquire camera images from camera(s) 104, respectively, or from memory 160. Though not shown, external processing system 180 may also include a memory that may be configured to store camera images, model outputs, among other data that may be used in data processing. BEV unit 194 may be configured to perform any of the techniques described as being performed by BEV unit 140. Control unit 196 may be configured to perform any of the techniques described as being performed by control unit 142 including ray densification operations.

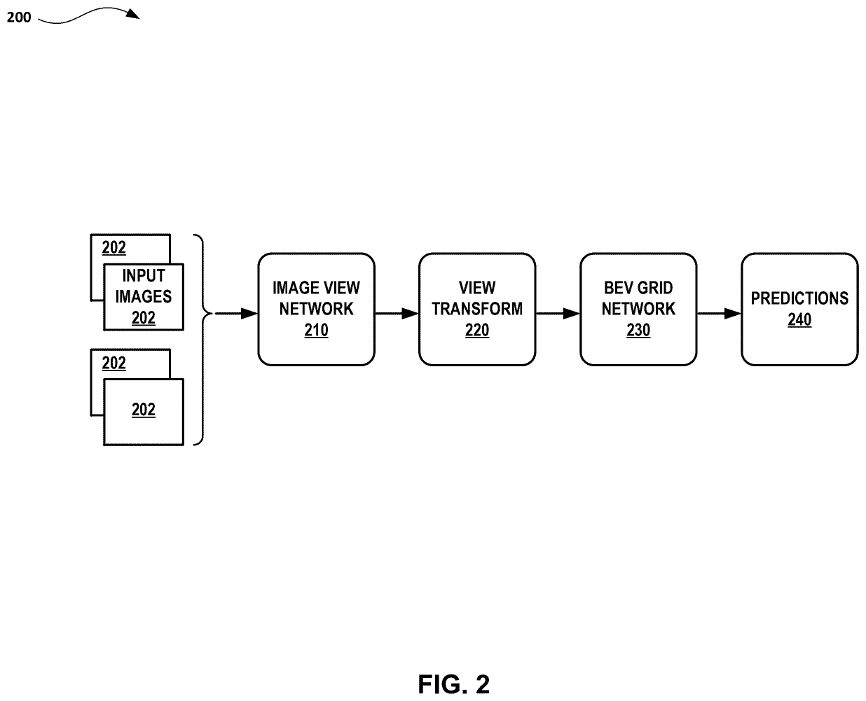

FIG. 2 is a block diagram illustrating an architecture for processing image data to generate predictive output from a bird's eye view (BEV) image space, in accordance with one or more techniques of this disclosure. FIG. 2 depicts input images 202 (e.g., camera images or image data) provided as input into an image view network 210. Image view network 210 may extract and/or generate camera features from input images 202 in advance of view transformation operations. During training, machine learning algorithms learn the characteristics of images from large datasets, allowing trained models to subsequently generate characteristics and features from new input images 202 obtained at inference time (e.g., such as while operating a vehicle equipped with an ADAS type processing system 100) based on generalizations learned during model training. Feature extraction techniques may utilize information within input images 202 such as raw pixel values, mean pixel values across channels, edge detection, pixel intensity, pixel depth information, and so forth, through the application of computer vision processing.

Input images 202 may be examples of camera images 168 of FIG. 1. In some examples, input images 202 may represent a set of camera images from camera images 168 and camera images 168 may include one or more camera images that are not present in input images 202. In some examples, input images 202 may be received from a plurality of cameras at different locations and/or different fields of view, which may be overlapping. In some examples, architecture 200 processes input images 202 in real-time or near real-time so that as camera(s) 104 captures input images 202, architecture 200 processes the captured camera images. In some examples, input images 202 may represent one or more perspective views of one or more objects within a 3D space where processing system 100 is located. That is, the one or more perspective views may represent views from the perspective of processing system 100.

Architecture 200 may transform input images 202 into BEV features that represent one or more objects within the 3D environment. For instance, view transform 220 may consume the BEV features to produce a BEV image from a perspective looking down at the one or more objects from a position above the one or more objects. BEV grid network 230 generates as output predictions 240 which may be utilized to generate useful output or perform useful tasks, such as object detection, object segmentation, displaying detected objects in a BEV format, providing a list of detected objects with their locations and predicted paths to another downstream function, identifying lane markers, displaying an area around a vehicle in a Bird's-Eye-View to back-up camera display, and so forth.

Since architecture 200 may be part of an ADAS for controlling a vehicle, and since vehicles move generally across the ground in a way that is observable from a BEV perspective, generating BEV images from view transform 220 may allow a control unit (e.g., control unit 142 and/or control unit 196) of FIG. 1 to control the vehicle based on the representation of the one or more objects from a bird's eye perspective based on predictions 240. Architecture 200 is not limited to generating predictions 240 for controlling a vehicle. Architecture 200 may generate predictions 240 for controlling another object such as a robotic arm and/or perform one or more other tasks involving image segmentation, depth detection, object detection, or any combination thereof.

Camera features generated or extracted by image view network 210 may be provided as input into view transform 220. As described above, view transform 220 generally converts data from the real world as represented by extracted camera image features and converts that information into something that can be used by processing system 100 for downstream computer vision operations. The specific techniques used for view transform 220 depend on the particular application and the characteristics of the input data (e.g., images, video frames, depth maps). View transform 220 performs data pre-processing enabling subsequent computer vision algorithms to operate effectively and accurately.

Example view transform 220 operations may include geometric transformation, color space transformation, projection and warping, normalization and standardization, depth and 3D reconstruction, and image enhancement. In the context of computer vision for an ADAS type system, view transform 220 operations may include depth perception and/or 3D reconstruction from images utilizing, for example, like stereo vision, structure-from-motion, etc., derive depth or reconstruct 3D geometry from 2D images. Projection type view transform 220 operations include mapping and aligning virtual objects with a real-world scene or environment from the perspective of an image source, such as cameras 104 of a vehicle. In one example, a depth vector is utilized having components or bins with values which indicate the probability of an object being at depth corresponding to the component or bin. For example, a depth vector with an example quantity of 128 bins has 128 depth regions from a closest to a furthest distance with values corresponding to a probability of an object being located at each bin. Different length depth vectors may be utilized. A context vector may be utilized to create, for each pixel, a number of parameters that relate to a context or attention.

Lift, Splat, Shoot (LSS) is one example of view transform 220 operations. The “lift” operation lifts (e.g., extracts) information from lower-dimensional representations (primarily two-dimensional (2D) representations) into higher-dimensional representations (primarily three-dimensional (3D) representations). Utilizing view transform 220, the lift operation enables extraction of information from multiple cameras and the subsequent fusing of the extracted information into a shared representation. For instance, the lift operation may include extracting data from the sensors, e.g. features from cameras, extracting distance information from LiDAR, etc., and positioning the extracted information into a 3D space. Such information may be compared with a LiDAR point cloud, in which each point not only contains “existence” information, but also a wide range of abstract features that have been extracted from an image. In pure camera-based LSS solutions, the resulting feature-filled point cloud may utilize calibration data, such as the position, rotation, and field of view for each camera, to create the point cloud.

Utilizing view transform 220, the splat operation consumes the feature-filled 3D point cloud and reduces the point-cloud dimensionality to 2D space. For instance, by removing information in the y-coordinate (height) and discretizing each point into distinct xz-coordinates based on a pre-defined BEV-grid resolution, the splat operation enables conversion of a 3D representation into a 2D representation. Consider, by way of illustration only, defining infinitely tall pillars (y-axis) with a pre-defined width (x-axis) and depth (z-axis), in which each point that was lifted in the lift step belongs to one of these pillars. In such an example, all points belonging to the same pillar will define the value for that pillar, either a singular value, such as existence for LiDAR, or multiple values, such as abstract features from camera(s).

The shoot operation may be utilized to “shoot” out navigation trajectories, as a part of the motion planning process of ADAS. However, the shoot operation is not needed as part of the creation of BEV features.

According to certain examples, application of LSS processes may utilize a BEVDet to perform ray casting operations. More particularly, a BEVDet unit may cast a number of rays equal to the dimensions of an Image View Network-output, (e.g., corresponding to camera image features. For instance, a grid size of 256×256 may be selected based on available resolution and configured detection distance. For example, consider a configurable detection distance of 50 meters in either direction (front, left, rear, right), with a resolution of at least 0.4 meters. In such an example, a grid size of at least 100/0.4=250×250, which is satisfied by the 256×256 grid size selection. Other resolutions and distances may result in different grid size selections within BEV grid network 230 representing the BEV image space. Other than theoretical experiments utilizing an infeasible number of cameras or image feature dimensions, BEV grid network 230 will, in practice, result in a BEV image space having areas of information sparsity, within which a majority of grid cells are equal to zero for all feature channels as a result of feature projection and ray-casting models, including LSS operations and BEVDet model output. The term “BEVDet” refers to “Bird's Eye View Detection,” as a specific approach or method used in computer vision, particularly in the context of autonomous driving and robotics. Other models may be similarly applied to attain similar results.

In accordance with at least one example, processing circuitry 110 (see FIG. 1) may be configured to generate a final depth distribution for each pixel location of the image data derived from input images 202 and projected into the BEV image space using the non-zero depth values of the feature pixels and the new non-zero depth values populated into the plurality of zero-value locations. According to such an example, processing circuitry 110 may be configured to apply a lift, splat, shoot (LSS) operation to generate the BEV grid network 230 having the BEV image space represented therein as a projection from the image data derived from input images 202 in a 2D perspective view format using the final depth distribution for each pixel of the image data within the BEV image space.

Output from view transform 220 is provided into BEV grid network 230 providing a model representation (e.g., a BEV image space) of the real-world. BEV grid network 230 refers to a specific type of neural network architecture designed for tasks involving top-down or overhead views of environments, hence the term “Bird's-Eye-View,” especially in the context of ADAS type systems, autonomous driving, and robotics. BEV grid network 230 is a type of a neural network that takes a BEV image as input and performs computer vision tasks. For instance, BEV grid network 230 may be configured to perform computer vision tasks including perception, localization, mapping, navigation, and decision-making processes to enable safe and efficient operation of autonomous vehicles and robots in complex environments. BEV grid network 230 may be configured to receive as input, the BEV image space having the greater information density and provide various types of output, such as occupancy (whether the space is occupied by an obstacle or not), semantic labels (like road, sidewalk, vehicles), estimated depth probability, or other relevant features.

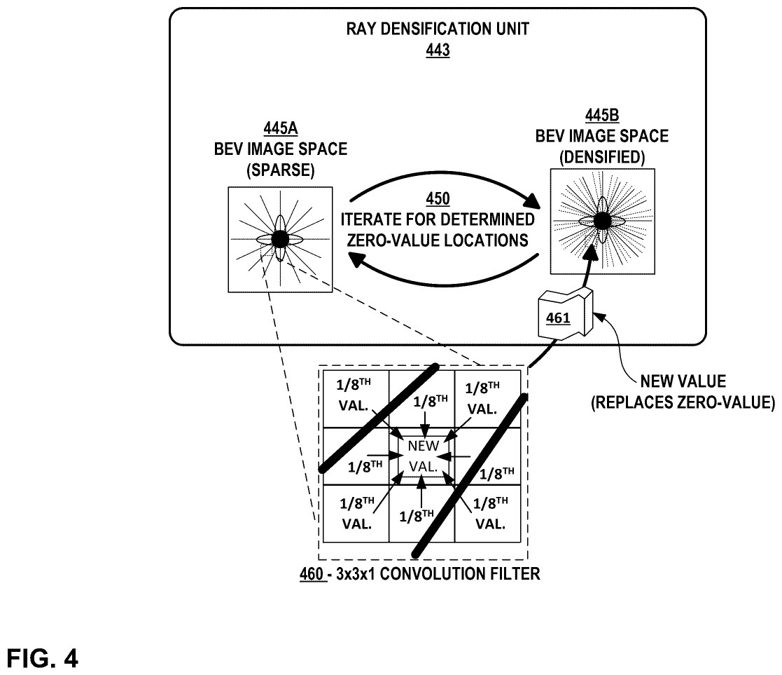

As discussed above, a location within a BEV image input into BEV grid network 230 may initially be empty, and thus a zero-value location, after projection of the camera features into the BEV image space. For instance, view transform 220 may generate a sparsely populated BEV image having empty locations and large regions of empty cells. Ray densifier 192, 197 (see FIG. 1) may be configured to densify the sparsely populated BEV image space using ray densification operations (see FIG. 4). For instance, all or a portion of a sparsely populated BEV image may be populated through the application of ray densification by spreading, scattering, or diffusing information from neighboring cell locations having information (e.g., non-zero value location) into nearby zero-value cell locations to provide an overall greater information density within the BEV image prior to providing the BEV image with greater information density as input into the BEV grid network 230. In some examples, certain empty regions of a BEV image having large swaths of zero value locations may be ignored, filtered out, or otherwise left as zero-value locations to enable more efficient use of processing circuitry 110.

BEV grid network 230 architecture is designed to process and analyze the modeled BEV image space efficiently utilizing convolutional neural networks (CNNs) or similar architectures optimized for spatial processing and feature extraction from grid-like data structures. BEV grid network 230 may enable the detection and localization of objects (such as vehicles, pedestrians) in autonomous driving scenarios. The grid-based representation allows for efficient spatial and contextual interpretation of the extracted camera features projected into the BEV image space. In certain examples, BEV grid network 230 may perform semantic segmentation tasks to label each grid cell with its corresponding semantic class (e.g., road, sidewalk, building), associate an estimated depth probability, or map other extracted feature information from the BEV image space on a per-pixel or per-cell location basis. BEV grid network 230 may enable improved path planning in the context of autonomous driving and robotics, by providing a clear representation of obstacles and navigable spaces from a top-down BEV perspective.

BEV grid network 230 generates predictions 240 as output for use with downstream computer vision operations, such as vehicle assistance tasks performed by an ADAS system, autonomous driving, etc.

Architecture 200 may use machine learning models such as convolutional neural network (CNN) layers to analyze the input data in a hierarchical manner. The CNN layers may apply filters to capture local patterns and gradually combine them to form higher-level features. Each convolutional layer extracts increasingly complex visual representations from input images 202.

During training, architecture 200 may be trained using a loss function that measures the discrepancy between input images 202 and a ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Architecture 200 may be trained using training data 170 from (see FIG. 1).

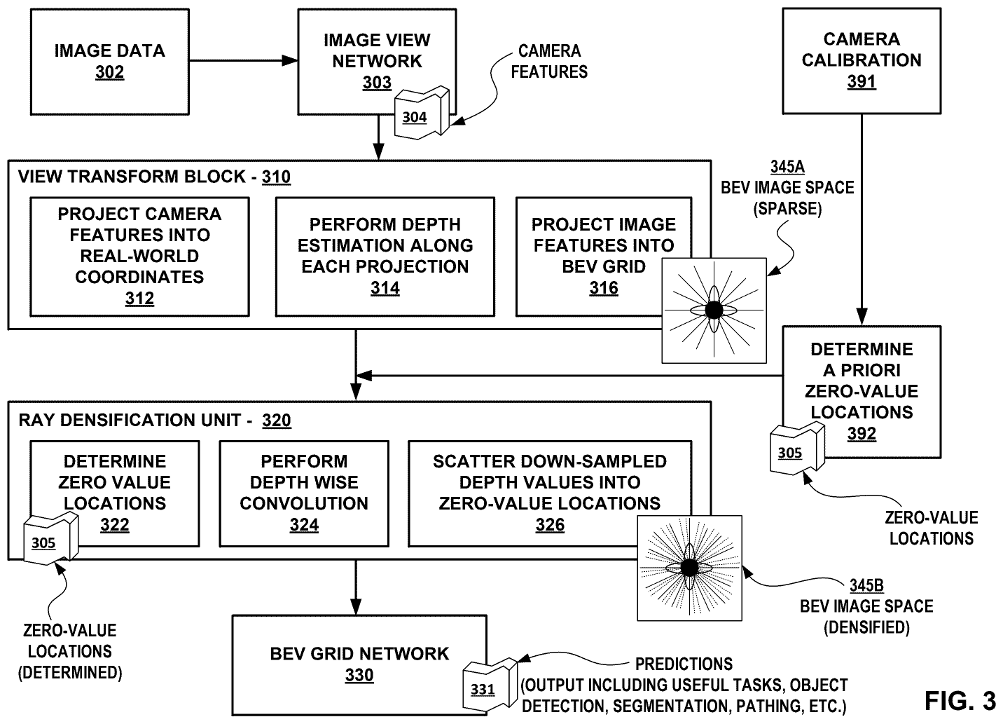

FIG. 3 is a flow diagram illustrating view transformation and ray densification, in accordance with one or more techniques of this disclosure. The functions of the flow diagram of FIG. 3 may be implemented using ray densifier 192, 197 and BEV units 140, 194 of FIG. 1 and/or architecture 200 of FIG. 2.

Image data 302 may be obtained, for instance, from one or more cameras including any combination of static images, video imagery, LiDAR information, radar information, etc. Image data 302 is provided as input to image view network 303 which extracts camera features 304 and other information from image data 302. Such camera features 304 are provided as input to view transform block 310 discussed previously in the context of view transform 220 at FIG. 2. As depicted here, view transform block 310 obtains camera features 304 and projects camera features 304 into real world coordinates (312). For instance, view transform block 310 may ray cast camera features 304 (e.g., two-dimensional (2D) features within a 2D coordinate grid of an original input image) into the real world coordinates to generate BEV features. For instance, view transform block 310 may be configured to fuse the 2D camera features from the 2D coordinate grid of the original input image to form 3D BEV features within the BEV image space as represented by a BEV coordinate grid). View transform block 310 may also be configured to generate depth estimations along each projection (314) of the 2D camera image features into the real world coordinates, resulting in the 2D camera image features projected into a BEV grid (316).

The BEV grid is a discretized representation of a transformed view provided as output from view transform operations. The BEV grid may divide a BEV image into a grid of cells, with each cell representing a small area of the environment. The BEV grid may be used for localization and mapping tasks in robotics and autonomous vehicles. By aligning data from different sensors (e.g., cameras, LiDAR, GPS, radar, etc.) onto a BEV grid, subsequent downstream computer vision tasks are enabled, such as localization, mapping, object detection and tracking, etc. Localization operations utilize the BEV grid to determine a precise position and orientation of a vehicle or robot relative to the environment surrounding the vehicle. Mapping operations build and update a map of the environment in a consistent and accurate manner based on updates to the BEV grid. Once the environment is represented in the BEV grid, object detection and tracking operations may localize and accurately track detected objects over time, providing useful output or performing useful tasks, such as navigating a vehicle safely through an environment within which the objects were detected and tracked. A simple example is an ADAS system of a vehicle utilizing the BEV grid to safely path through an environment using the detected object information, for instance, identifying lane markers, maintaining a position within a lane, identifying and acting appropriately to road signals such as stop signs and stop lights, and avoiding detected objects corresponding to other vehicles, pedestrians, bicycles, and so forth. Path planning and navigation operations may utilize output from BEV grids to facilitate path planning algorithms by providing a structured representation of obstacles, drivable areas, and other relevant features to generate safe, efficient, and legally compliant (e.g., stopping at a red light even when a path is clear), trajectories for the vehicle or robot to follow.

As depicted here, a BEV image space 345A depicts several ray casts projected into the BEV image space resulting. Initially, BEV image space 345A may be sparsely populated with BEV features and depth vectors. As shown, BEV image space 345A includes regions of empty locations nearest each of the four corners and areas of sparsely populated information which become increasingly sparse between each of the respective rays farther out from a source point due to the nature of radially projecting camera feature 304 information from the center of the BEV image space 345A.

Ray densification unit 320 is configured to increase the information density of the BEV features and depth information in BEV image space 345A. The BEV features and depth information in BEV image space 345A is initially sparsely populated. Ray densification unit 320 may be configured to generate a more densely populated BEV image space 345B (e.g., to produce increased density BEV features). Separately, ray densification unit 320 may use camera calibration 391 information to determine a priori zero-value locations 305 (392) within the BEV image space 345A. For any given camera configuration, camera calibration 391 only needs to be performed once (until the position of the cameras are changed) from which, a priori zero-value locations 305 may be deterministically identified (392) as the projection of camera features 304 into the real world coordinates (312) will result in the same zero-value locations 305 in the same BEV grid network 330 cells every time. To be clear, the non-zero-value locations may have different information for any given image data 302 due to changing camera features 304 extracted from the obtained image data 302, however, the projection by view transform block 310 will result in zero-value locations 305 being the same for each iteration, thus allowing zero-value locations 305 to be pre-determined or deterministically identified once and repeatedly utilized during downstream processing operations, such as those performed by ray densification unit 320.

Ray densification unit 320 is configured to obtain zero-value locations 305 as input (e.g., based on the calibration 391 information) and determine zero value locations 305 (322) for processing. In some examples, all zero-value locations 305 are processed. In other examples, some portion of zero-value locations 305 are processed. For example, determining zero-value locations 305 (322) may include filtering out all non-zero-value locations from BEV grid network 330, selecting and utilizing all or a portion of zero-value locations 305 based on a priori camera calibration 391 information, forming a subset of zero-value locations 305 by eliminating areas of zero-value locations 305, such as the areas within the four corners of the BEV image space into which no camera feature 304 information was projected, or some other processing operation via which to identify and determine which zero-value locations 305 are to be operated upon.

As depicted, ray densification unit 320 may be configured to apply depth-wise convolution (324) to spread, scatter, or otherwise diffuse information from non-zero-value locations populated with information into zero-value locations 305 lacking any camera feature 304 information within the sparsely populated BEV image space 345A. For instance, in at least one example, ray densification unit 320 includes processing circuitry 110 configured to diffuse non-zero BEV camera features 304 in the BEV image space 345A into a plurality of zero-value locations 305 through the application of depth-wise convolution operations on the plurality of zero-value locations 305 determined within the BEV image space 345 (322).

Ray densification unit 320 may be configured to supplant zero value locations 305 in BEV image space 345B resulting in greater information density from which BEV grid network 330 may then generate, as output, prediction(s) 331. For instance, predictions 331 may include the various useful tasks and useful output for further downstream computer vision operations, such as object detection, object localization, object segmentation, pathing operations, outputting for display, BEV images to a user interface (e.g., such as a back-up camera displaying a top-down view of an environment surrounding a vehicle), etc.

FIG. 4 is a diagram of an example convolution filter applied to zero value locations to densify camera features within a BEV image space, in accordance with one or more techniques of this disclosure. More particularly, FIG. 4 depicts ray densification unit 443 iteratively operating on determined zero-value locations (450) of BEV image space 445A having sparsely populated BEV grid cell locations to create BEV image space 445B having a greater information density and fewer zero value locations than BEV image space 445A. Ray densification unit 443 may operate via processing system 100 of FIG. 1, architecture 200 of FIG. 2, in accordance with the flow diagram of FIG. 3., or some combination thereof.

As depicted, ray densification unit 443 may replace or supplant zero-value locations within BEV image space 445A with new values 461 within BEV image space 445B. Ray densification unit 443 may operate on a single BEV image space 445A-B by iteratively replacing each of a plurality of determined zero-value locations (450) with new non-zero-value locations derived from neighboring BEV grid network cell locations. In such a way, ray densification unit 443 may overwrite or otherwise supplant, update, or replace the initially zero-value locations within BEV image space 445A which after processing, results in BEV image space 445B. In other examples, ray densification may create a new densified BEV image space 445B, for instance, where memory constraints are non-limiting to ray densification unit 443 processing or when creating a new BEV image space 445B with the greater information density is more computationally efficient and/or incurs less latency than updating BEV image space 445A.

In a particular example, ray densification applies a 3×3×1 convolutional filter to generate a new value for a zero-value location from surrounding (e.g., immediately adjacent neighboring locations). The use of a 3×3×1 convolution filter 460 may be selected based upon implementation needs and different filter sizes and configurations may be utilized. Use of 3×3×1 convolution filter 460 size enables straightforward weighting and down-sampling logic as 3×3×1 convolution filter 460 has 9 total locations, with the center location being the zero-value location to be replaced with a new value and with the remaining 8 locations being available as source locations from which to diffuse (e.g., down-sample, spread, scatter, etc.) information into the center zero-value location in the manner depicted by FIG. 4. Notably, because there are eight source locations, application of a simple ⅛th weight will result in a new value for the center cell having a minimum value of 0 and a maximum value of 1, thus remaining consistent with other estimated depth probabilities for all cells within BEV image space 445A which share a range from a minimum value of 0 to a maximum value of 1. To be clear, if all eight source cells have minimum values of 0, then the resulting value for the new cell will be 0. Similarly, if all eight source cells had maximum values of 1, then again, taking ⅛th of each of the source cells with a maximum value of 1 will simply result in the new value of the center cell (previously zero) being set to a maximum value of 1. In a more likely example, the surrounding cells representing the eight source locations will have a variety of values between 0 and 1 resulting in the diffusion into the center cell replacing the initially zero-value cell with some value between 0 and 1 as a down-sampled representation of the eight surrounding source cells.

Therefore, in accordance with at least one example, processing circuitry 110 of a processing system 100 may optionally be configured to perform depth-wise convolution operations (see FIG. 3 at element 324) by generating a 3×3×1 depth-wise convolution filter having all values of the 3×3×1 depth-wise convolution filter equal to ⅛th of the non-zero BEV features neighboring a respective one of the plurality of zero-value locations determined within the BEV image space. In such an example, processing circuitry 110 may also be configured to populate the respective one of the plurality of zero-value locations (e.g., the center cell location within 3×3×1 convolution filter 460) determined within the BEV image space 345A with a sum of the values of 3×3×1 convolution filter 460. In such a way, ray densification unit 443 may scatter down-sampled depth values into zero value locations (see FIG. 3 at elements 305 and 326) as well as spreading other camera feature 304 (see FIG. 3) information from neighboring cell locations of the BEV image space 445B to provide greater information density for downstream computer vision processing operations.

FIG. 5 depicts an example view transform output map before information densification, in accordance with one or more techniques of this disclosure. FIG. 5 is described with respect to processing system 100 and external processing system 180 of FIG. 1, architecture 200 of FIG. 2, and the methods and operations discussed in FIGS. 3 and 4.

More particularly, FIG. 5 depicts BEV image space 545 (e.g., a view transform output map prior to performing ray densification (e.g., see BEV image space 445A at FIG. 4). Therefore, BEV image space 545 includes all of the initially zero-value locations and may therefore be considered to have regions of information sparsity. In particular, each of the corners of BEV image space 545 depict entirely empty spaces 560 within which the radially outward projected rays do not reach due to their distance from a center source point (e.g., source camera position) of BEV image space 545. Because the corners will always produce empty spaces 560 based on a known camera calibration, the empty spaces may simply be ignored to increase computational efficiency. On the other hand, regions 570 nearest a center source location of BEV image space 545 correspond with regions of greatest information density, even prior to densification, as the distance between adjacent projected rays is smallest within BEV image space resulting in camera feature locations being nearest to each other. Regions 565 represent areas of information sparsity as the density of information decreases with distance from a center camera source location within the BEV image space. Stated differently, the farther out along any given projected ray any pixel or camera feature location is positioned, the greater the distance to any adjacently projected ray, thus resulting in a greater area of zero-value locations between populated locations of the projected rays. Ray densification unit 320, 443 (see FIGS. 3 and 4) may therefore be configured to increase overall information density within the BEV image space by diffusing down-sampled information from the populated non-zero-value locations along the rays into adjacent or neighboring locations initially having zero-value or lacking information.

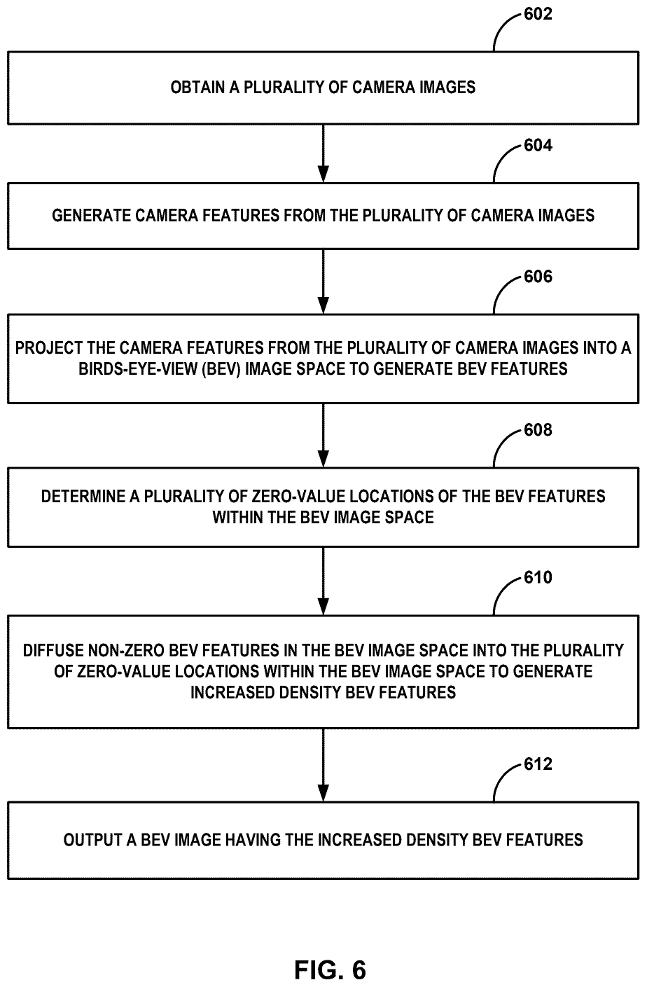

FIG. 6 is a flow diagram illustrating an example method for densifying rays sparsely cast into a bird's eye view (BEV) image space to improve subsequent BEV image generation, in accordance with one or more techniques of this disclosure. FIG. 6 is described with respect to processing system 100 and external processing system 180 of FIG. 1, architecture 200 of FIG. 2, and the methods discussed in FIGS. 3, 4, and 5. However, the techniques of FIG. 6 may be performed by different components of processing system 100, external processing system 180, architecture 200, or by additional or alternative systems.

Processing circuitry 110 may be configured to obtain plurality of camera images 168 (602). According to such an example, processing circuitry 110 may be configured to generate camera features 304 from a plurality of camera images 168 (604). Continuing with such an example, processing circuitry 110 may be configured to project camera features 304 from plurality of camera images 168 into a birds-eye-view (BEV) image space 345A to generate BEV features (606). In some examples, processing circuitry 110 is configured to determine a plurality of zero-value locations 305 of the BEV features within BEV image space 345A (608). Processing circuitry 110 may be configured to diffuse non-zero BEV features in BEV image space 345A into the plurality of zero-value locations within BEV image space 345A to generate increased density BEV features (610). For instance, processing circuitry 110 may be configured to generate increased density BEV features within a densified BEV image space 345B. In at least one example, processing circuitry 110 is configured to output a BEV image having the increased density BEV features (612). For example, processing circuitry 110 may be configured to output a BEV image from a densified BEV image space 345B. In other examples, processing circuitry 110 is configured to output predictions which may be utilized to generate a BEV image from densified BEV image space 345B or generate useful tasks such as pathing, object segmentation, object detection and localization, decision making for autonomous vehicles and robots, etc.

Additional aspects of the disclosure are detailed in numbered clauses below.

Clause 1—An apparatus for processing image data, the apparatus comprising: a memory for storing the image data; and processing circuitry in communication with the memory, wherein the processing circuitry is configured to: obtain a plurality of camera images; generate camera features from the plurality of camera images; project the camera features from the plurality of camera images into a birds-eye-view (BEV) image space to generate BEV features; determine a plurality of zero-value locations of the BEV features within the BEV image space; diffuse non-zero BEV features in the BEV image space into the plurality of zero-value locations within the BEV image space to generate increased density BEV features; and output a BEV image having the increased density BEV features.

Clause 2—The apparatus of clause 1, wherein to project the camera features from the plurality of camera images into the BEV image space to generate the BEV features, the processing circuitry is configured to: generate estimated depth probabilities for the camera features; and ray cast the camera features into the BEV image space to generate a plurality of rays in the BEV image space, wherein the rays correspond to the non-zero BEV features weighted using the estimated depth probabilities for the camera features.

Clause 3—The apparatus of any of clauses 1-2, wherein to diffuse the non-zero BEV features in the BEV image space into the plurality of zero-value locations within the BEV image space, the processing circuitry is configured to: perform depth-wise convolution operations on the plurality of zero-value locations within the BEV image space determined within the BEV image space to generate the increased density BEV features.

Clause 4—The apparatus of any of clauses 1-3, wherein to perform the depth-wise convolution operations, the processing circuitry is configured to: generate a 3×3×1 depth-wise convolution filter having all values of the 3×3×1 depth-wise convolution filter equal to ⅛th of the non-zero BEV features neighboring a respective one of the plurality of zero-value locations determined within the BEV image space; and populate the respective one of the plurality of zero-value locations determined within the BEV image space with a sum of the values of the 3×3×1 depth-wise convolution filter.

Clause 5—The apparatus of any of clauses 1-4, wherein to determine the plurality of zero-value locations within the BEV image space, the processing circuitry is configured to: determine the plurality of zero-value locations within the BEV image space based on a priori calibration information defining the plurality of zero-value locations within the BEV image space prior to the plurality of camera images being obtained.

Clause 6—The apparatus of any of clauses 1-5, wherein to determine the plurality of zero-value locations within the BEV image space, the processing circuitry is configured to: determine the plurality of zero-value locations within the BEV image space utilizing a filter operation to remove camera features having non-zero depth values from a subset of the camera features, wherein the subset of the camera features includes only the plurality of zero-value locations subsequent to the filter operation.

Clause 7—The apparatus of any of clauses 1-6, wherein to determine the plurality of zero-value locations within the BEV image space, the processing circuitry is configured to: define a set of zero-value locations within the BEV image space; prior to the processing circuitry to project the camera features from the plurality of camera images into the BEV image space to generate BEV features, the processing circuitry is configured to: remove, from the set of zero-value locations within the BEV image space, a subset of the zero-value locations located within pre-defined areas of the BEV image space including one or more corners of the BEV image space; and determine the plurality of zero-value locations within the BEV image space as corresponding to the set of the zero-value locations having the subset of the zero-value locations removed.

Clause 8—The apparatus of any of clauses 1-7, wherein to diffuse the non-zero BEV features in the BEV image space into the plurality of zero-value locations within the BEV image space, the processing circuitry is configured to: apply a convolution operation to the plurality of zero-value locations within the BEV image space to populate the plurality of zero-value locations determined within the BEV image space with new non-zero depth values; and wherein to apply the convolution operation to the plurality of zero-value locations within the BEV image space, the processing circuitry is configured to: distribute down-scaled depth information from the non-zero BEV features into the plurality of zero-value locations determined within the BEV image space to decrease a total number of zero-value locations remaining within the BEV image space.

Clause 9—The apparatus of any of clauses 1-8, wherein the processing circuitry is further configured to: send the BEV image having the increased density BEV features as input to at least one machine learning model, wherein the at least one machine learning model is to perform, based on the input, one or more tasks including: output a plurality of objects detected within the BEV image having the increased density BEV features; output object segmentation features for the plurality of objects within the BEV image having the increased density BEV features; output depths and locations for the plurality of objects within the BEV image having the increased density BEV features; output for display in a BEV format, the plurality of objects within the BEV image having the increased density BEV features; and output a predicted safe path of travel to an advanced driver assistance system (ADAS) in control of a vehicle based on the plurality of objects within the BEV image having the increased density BEV features.

Clause 10—The apparatus of any of clauses 1-9, wherein the processing circuitry and the memory are part of an advanced driver assistance system (ADAS).

Clause 11—The apparatus of any of clauses 1-10, wherein the processing circuitry is configured to use the BEV image having the increased density BEV features to control a vehicle.

Clause 12—The apparatus of any of clauses 1-11, wherein the apparatus further comprises: one or more cameras configured to capture the one or more camera images.

Clause 13—A method of processing image data comprising: obtaining a plurality of camera images; generating camera features from the plurality of camera images; projecting the camera features from the plurality of camera images into a birds-eye-view (BEV) image space to generate BEV features; determining a plurality of zero-value locations of the BEV features within the BEV image space; diffusing non-zero BEV features in the BEV image space into the plurality of zero-value locations within the BEV image space to generate increased density BEV features; and outputting a BEV image having the increased density BEV features.

Clause 14—The method of clause 13, wherein projecting the camera features from the plurality of camera images into the BEV image space to generate the BEV features, includes: generating estimated depth probabilities for the camera features; and ray casting the camera features into the BEV image space to generate a plurality of rays in the BEV image space, wherein the rays correspond to the non-zero BEV features weighted using the estimated depth probabilities for the camera features.

Clause 15—The method of any of clauses 13-14, wherein diffusing the non-zero BEV features in the BEV image space into the plurality of zero-value locations within the BEV image space, includes: performing depth-wise convolution operations on the plurality of zero-value locations within the BEV image space determined within the BEV image space to generate the increased density BEV features.

Clause 16—The method of any of clauses 13-15, wherein performing the depth-wise convolution operations, includes: generating 3×3×1 depth-wise convolution filter having all values of the 3×3×1 depth-wise convolution filter equal to ⅛th of the non-zero BEV features neighboring a respective one of the plurality of zero-value locations determined within the BEV image space; and populating the respective one of the plurality of zero-value locations determined within the BEV image space with a sum of the values of the 3×3×1 depth-wise convolution filter.

Clause 17—The method of any of clauses 13-16, wherein determining the plurality of zero-value locations within the BEV image space, includes: determining the plurality of zero-value locations within the BEV image space based on a priori calibration information defining the plurality of zero-value locations within the BEV image space prior to the plurality of camera images being obtained.

Clause 18—The method of any of clauses 13-17, wherein determining the plurality of zero-value locations within the BEV image space, includes: determining the plurality of zero-value locations within the BEV image space utilizing a filter operation to remove camera features having non-zero depth values from a subset of the camera features, wherein the subset of the camera features includes only the plurality of zero-value locations subsequent to the filter operation.

Clause 19—The method of any of clauses 13-18, wherein determining the plurality of zero-value locations within the BEV image space, includes: defining a set of zero-value locations within the BEV image space; prior to the processing circuitry to project the camera features from the plurality of camera images into the BEV image space to generate BEV features, the method further includes: removing, from the set of zero-value locations within the BEV image space, a subset of the zero-value locations located within pre-defined areas of the BEV image space including one or more corners of the BEV image space; and determining the plurality of zero-value locations within the BEV image space as corresponding to the set of the zero-value locations having the subset of the zero-value locations removed.

Clause 20—A non-transitory computer-readable medium storing instructions that, when executed, cause processing circuitry to: obtain a plurality of camera images; generate camera features from the plurality of camera images; project the camera features from the plurality of camera images into a birds-eye-view (BEV) image space to generate BEV features; determine a plurality of zero-value locations of the BEV features within the BEV image space; diffuse non-zero BEV features in the BEV image space into the plurality of zero-value locations within the BEV image space to generate increased density BEV features; and output a BEV image having the increased density BEV features.

Clause 21—An apparatus comprising means for performing any combination of techniques of clauses 13-19.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data, the apparatus comprising:
a memory for storing the image data; and
processing circuitry in communication with the memory, wherein the processing circuitry is configured to:
obtain a plurality of camera images;
generate camera features from the plurality of camera images;
project the camera features from the plurality of camera images into a birds-eye-view (BEV) image space to generate BEV features;
determine a plurality of zero-value locations of the BEV features within the BEV image space;
diffuse non-zero BEV features in the BEV image space into the plurality of zero-value locations within the BEV image space to generate increased density BEV features; and
output a BEV image having the increased density BEV features.

2. The apparatus of claim 1, wherein to project the camera features from the plurality of camera images into the BEV image space to generate the BEV features, the processing circuitry is configured to:
generate estimated depth probabilities for the camera features; and
ray cast the camera features into the BEV image space to generate a plurality of rays in the BEV image space, wherein the rays correspond to the non-zero BEV features weighted using the estimated depth probabilities for the camera features.

3. The apparatus of claim 1, wherein to diffuse the non-zero BEV features in the BEV image space into the plurality of zero-value locations within the BEV image space, the processing circuitry is configured to:
perform depth-wise convolution operations on the plurality of zero-value locations within the BEV image space determined within the BEV image space to generate the increased density BEV features.

4. The apparatus of claim 3, wherein to perform the depth-wise convolution operations, the processing circuitry is configured to:
generate a 3×3×1 depth-wise convolution filter having all values of the 3×3×1 depth-wise convolution filter equal to ⅛th of the non-zero BEV features neighboring a respective one of the plurality of zero-value locations determined within the BEV image space; and
populate the respective one of the plurality of zero-value locations determined within the BEV image space with a sum of the values of the 3×3×1 depth-wise convolution filter.

5. The apparatus of claim 1, wherein to determine the plurality of zero-value locations within the BEV image space, the processing circuitry is configured to:
determine the plurality of zero-value locations within the BEV image space based on a priori calibration information defining the plurality of zero-value locations within the BEV image space prior to the plurality of camera images being obtained.

6. The apparatus of claim 1, wherein to determine the plurality of zero-value locations within the BEV image space, the processing circuitry is configured to:
determine the plurality of zero-value locations within the BEV image space utilizing a filter operation to remove camera features having non-zero depth values from a subset of the camera features, wherein the subset of the camera features includes only the plurality of zero-value locations subsequent to the filter operation.

7. The apparatus of claim 1, wherein to determine the plurality of zero-value locations within the BEV image space, the processing circuitry is configured to:
define a set of zero-value locations within the BEV image space;
prior to the processing circuitry to project the camera features from the plurality of camera images into the BEV image space to generate BEV features, the processing circuitry is configured to:
remove, from the set of zero-value locations within the BEV image space, a subset of the zero-value locations located within pre-defined areas of the BEV image space including one or more corners of the BEV image space; and
determine the plurality of zero-value locations within the BEV image space as corresponding to the set of the zero-value locations having the subset of the zero-value locations removed.

8. The apparatus of claim 1, wherein to diffuse the non-zero BEV features in the BEV image space into the plurality of zero-value locations within the BEV image space, the processing circuitry is configured to:
apply a convolution operation to the plurality of zero-value locations within the BEV image space to populate the plurality of zero-value locations determined within the BEV image space with new non-zero depth values; and
wherein to apply the convolution operation to the plurality of zero-value locations within the BEV image space, the processing circuitry is configured to:
distribute down-scaled depth information from the non-zero BEV features into the plurality of zero-value locations determined within the BEV image space to decrease a total number of zero-value locations remaining within the BEV image space.

9. The apparatus of claim 1, wherein the processing circuitry is further configured to:
send the BEV image having the increased density BEV features as input to at least one machine learning model, wherein the at least one machine learning model is to perform, based on the input, one or more tasks including:
output a plurality of objects detected within the BEV image having the increased density BEV features;
output object segmentation features for the plurality of objects within the BEV image having the increased density BEV features;
output depths and locations for the plurality of objects within the BEV image having the increased density BEV features;
output for display in a BEV format, the plurality of objects within the BEV image having the increased density BEV features; and
output a predicted path of travel to an advanced driver assistance system (ADAS) in control of a vehicle based on the plurality of objects within the BEV image having the increased density BEV features.

10. The apparatus of claim 1, wherein the processing circuitry and the memory are part of an advanced driver assistance system (ADAS).

11. The apparatus of claim 1, wherein the processing circuitry is configured to use the BEV image having the increased density BEV features to control a vehicle.

12. The apparatus of claim 1, wherein the apparatus further comprises:
one or more cameras configured to capture the one or more camera images.

13. A method of processing image data comprising:
obtaining a plurality of camera images;
generating camera features from the plurality of camera images;
projecting the camera features from the plurality of camera images into a birds-eye-view (BEV) image space to generate BEV features;
determining a plurality of zero-value locations of the BEV features within the BEV image space;
diffusing non-zero BEV features in the BEV image space into the plurality of zero-value locations within the BEV image space to generate increased density BEV features; and
outputting a BEV image having the increased density BEV features.

14. The method of claim 13, wherein projecting the camera features from the plurality of camera images into the BEV image space to generate the BEV features, includes:
generating estimated depth probabilities for the camera features; and
ray casting the camera features into the BEV image space to generate a plurality of rays in the BEV image space, wherein the rays correspond to the non-zero BEV features weighted using the estimated depth probabilities for the camera features.

15. The method of claim 13, wherein diffusing the non-zero BEV features in the BEV image space into the plurality of zero-value locations within the BEV image space, includes:
performing depth-wise convolution operations on the plurality of zero-value locations within the BEV image space determined within the BEV image space to generate the increased density BEV features.

16. The method of claim 15, wherein performing the depth-wise convolution operations, includes:
generating a 3×3×1 depth-wise convolution filter having all values of the 3×3×1 depth-wise convolution filter equal to ⅛th of the non-zero BEV features neighboring a respective one of the plurality of zero-value locations determined within the BEV image space; and
populating the respective one of the plurality of zero-value locations determined within the BEV image space with a sum of the values of the 3×3×1 depth-wise convolution filter.

17. The method of claim 13, wherein determining the plurality of zero-value locations within the BEV image space, includes:
determining the plurality of zero-value locations within the BEV image space based on a priori calibration information defining the plurality of zero-value locations within the BEV image space prior to the plurality of camera images being obtained.

18. The method of claim 13, wherein determining the plurality of zero-value locations within the BEV image space, includes:
determining the plurality of zero-value locations within the BEV image space utilizing a filter operation to remove camera features having non-zero depth values from a subset of the camera features, wherein the subset of the camera features includes only the plurality of zero-value locations subsequent to the filter operation.

19. The method of claim 13, wherein determining the plurality of zero-value locations within the BEV image space, includes:
defining a set of zero-value locations within the BEV image space;
prior to projecting the camera features from the plurality of camera images into the BEV image space to generate BEV features, the method further includes:
removing, from the set of zero-value locations within the BEV image space, a subset of the zero-value locations located within pre-defined areas of the BEV image space including one or more corners of the BEV image space; and
determining the plurality of zero-value locations within the BEV image space as corresponding to the set of the zero-value locations having the subset of the zero-value locations removed.

20. A non-transitory computer-readable medium storing instructions that, when executed, cause processing circuitry to:
obtain a plurality of camera images;
generate camera features from the plurality of camera images;
project the camera features from the plurality of camera images into a birds-eye-view (BEV) image space to generate BEV features;
determine a plurality of zero-value locations of the BEV features within the BEV image space;
diffuse non-zero BEV features in the BEV image space into the plurality of zero-value locations within the BEV image space to generate increased density BEV features; and
output a BEV image having the increased density BEV features.
